(19) United States
(12) Patent Application Publication
(10) Pub. No.: US 2025/0232524 A1
(43) Pub. Date: Jul. 17, 2025

(54) Dynamic Lighting Adjustments in a 3D Environment

(71) Applicant: Apple Inc., Cupertino, CA (US)

(72) Inventors: Mariano Merchante, Culver City, CA (US); William T Parks, Culver City, CA (US)

(21) Appl. No.: 19/011,781

(22) Filed: Jan. 7, 2025

Related U.S. Application Data
(60) Provisional application No. 63/620,345, filed on Jan. 12, 2024.

(51) Int. Cl. G06T 15/50; G06T 15/00; G06T 19/20

(52) U.S. Cl. CPC G06T 15/506; G06T 15/005; G06T 19/20; G06T 2219/2016

(57) ABSTRACT

Various implementations disclosed herein include devices, systems, and methods for determining adjustments of lighting effects for content based on environment lighting. For example, a process may include generating a representation that specifies lighting effects for a plurality of normal directions on a sample shape at a position of 3D content within a 3D environment. The process may further include obtaining position data corresponding to viewpoint positions within the 3D environment. The process may further include updating the representation based on the position data to maintain a static orientation of the lighting effects specified by the representation relative to the 3D environment. The process may further include determining changes to portions of the 3D content based on lighting effects specified for corresponding representation normal directions. The process may further include determining depictions of the 3D content adjusted based on the changes to the plurality of portions of the 3D content.

### CROSS-REFERENCE TO RELATED APPLICATIONS

This application claims the benefit of U.S. Provisional Application Ser. No. 63/620,345 filed Jan. 12, 2024, which is incorporated herein by reference in its entirety.

### TECHNICAL FIELD

The present disclosure generally relates to systems, methods, and electronic devices for providing dynamic lighting adjustments for portions of content for a view of a three-dimensional (3D) environment.

### BACKGROUND

Existing rendering techniques for light adjustments may use an undesirable amount of an electronic device's resources (e.g., a computer processing unit (CPU) and/or a graphical processing unit (GPU) computation, software architecture, time, power, etc.) to apply lighting effects. Existing rendering techniques may use a computationally-expensive process, such as, inter alia, pre-convolved image base lighting, to separately calculate the change of lighting to apply to each portion of content. Thus, there is a need for improved techniques for efficiently providing dynamic lighting adjustments for content within views of a three-dimensional (3D) environment.

### SUMMARY

Various implementations disclosed herein include devices, systems, and methods that provides dynamic lighting adjustments for portions of content for a view of a three-dimensional (3D) environment. In particular, various implementations adjust lighting effects by changing the appearance of different portions of 3D content (e.g., a character or other object) based on environment lighting. Rather than using a computationally expensive process, such as, inter alia, pre-convolved image base lighting, to separately calculate the change to apply to each portion, the techniques disclosed herein assume that portions of the object having similar surface normal directions should have similar lighting effects. Therefore, the techniques disclosed herein create a representation (e.g., a sphere) that defines the lighting effects to apply to each of multiple normal directions on the surfaces of the object based on evaluating the environment lighting.

In some implementations, the lighting adjustment techniques disclosed herein may determine the changes to apply to a given portion of the 3D content by using a respective portion's normal direction to look up or sample information from the representation. For example, finding the lighting effect of the representation point having the most similar normal direction. Over a period of time, as a user's viewpoint within a 3D environment changes, the representation may be adjusted (e.g., reorienting the sample shape based on viewpoint changes) to maintain a static orientation of the lighting information in world-space, so that the stored lighting effects consistently correspond to the environment lighting over time. In some implementations, the representation may be used for multiple frames. For example, the representation doesn't need to be recalculated for every frame since a viewpoint may not change much between frames (e.g., a user looking at an object at a particular viewpoint for a long period of time).

In some implementations, the techniques described herein may calculate multiple textures for different lighting effects (e.g., specular, diffuse, etc.) or may be modified based on determining different reflective properties associated with the materials of the object (e.g., skin, metal, plastic, etc.). In some implementations, using a sphere-based representation may provide power and efficiency advantages. For example, sampling a 32×32 patch of a sphere-based representation (also referred to herein as “lit spheres” or “dynamic spherelit”) may be more cache friendly than sampling cubemaps. For example, a sample patch may have a smaller size texture that can be looked up which is great for efficiency in that the sample patch can be calculated more easily and it fits in the cache better. Moreover, the sample patch of the sphere-based representation may only need to be calculated and updated every couple of frames or as desired because a view adjustment is typically not great enough to require an update every frame.

In some implementations, edge computing may be utilized to update lighting effects by utilizing data from one or more other devices. For example, a head mounted device (HMD) may determine the generation and rotation-based adjustment of the representation may be performed remotely from an HMD that is displaying the content based on current device pose and/or other information provided by the HMD.

In general, one innovative aspect of the subject matter described in this specification can be embodied in methods that include the actions of, at a device having a processor, generating a representation that specifies lighting effects for a plurality of normal directions on a sample shape at a position of three-dimensional (3D) content within a 3D environment, the lighting effects determined based on lighting conditions in the 3D environment. The actions may further include obtaining position data corresponding to viewpoint positions within the 3D environment, the viewpoint positions corresponding to views of the 3D environment. The actions may further include updating the representation based on the position data to maintain a static orientation of the lighting effects specified by the representation relative to the 3D environment. The actions may further include determining changes to a plurality of portions of the 3D content based on lighting effects specified for corresponding representation normal directions in the plurality of normal directions of the representation, the corresponding representation normal directions identified based on similarity to normal directions of the plurality of portions of the 3D content. The actions may further include determining depictions of the 3D content adjusted based on the changes to the plurality of portions of the 3D content.

These and other embodiments may each optionally include one or more of the following features.

In some aspects, the representation includes a texture that stores lighting information for multiple normal directions associated with multiple surface points on the sample shape. In some aspects, the representation includes a plurality of values, wherein each value of the plurality of values corresponds to a different normal direction, are positioned in a spatial arrangement, or a combination thereof.

In some aspects, determining the changes to the plurality of the portions of the 3D content based on lighting effects specified for corresponding representation normal directions in the plurality of normal directions of the representation includes applying the lighting effects based on a sample texture value at a corresponding normal for each pixel of a plurality of pixels within a current view.

In some aspects, determining the changes to the plurality of the portions of the 3D content based on lighting effects specified for corresponding representation normal directions in the plurality of normal directions of the representation includes rendering an outgoing radiance. In some aspects, rendering the outgoing radiance is based on sampling image-based lighting (IBL) from sensor data.

In some aspects, the views of the 3D environment include a viewing frame rate, wherein the depictions of the 3D content that are adjusted based on the changes to the plurality of portions of the 3D content are updated at a light adjustment frame rate that is a different frame rate than the viewing frame rate.

In some aspects, updating the representation includes adjusting data associated with the representation based on translating the sample shape to correspond to a current viewpoint. In some aspects, updating the representation includes adjusting data associated with the representation based on rotating the sample shape to correspond to a current viewpoint.

In some aspects, the device is a first device, wherein the views of the 3D environment that include depictions of the adjusted 3D content are updated based on a generation and rotation-based adjustment of the representation by a second device. In some aspects, the device is a first device, and wherein the changes to the plurality of portions of the 3D content based on additional lighting effects specified for corresponding representation normal directions in the plurality of normal directions of the representation are obtained from one or more other devices that are different than the first device.

In some aspects, the lighting effects are determined based on the lighting conditions in the 3D environment is based on sensor data from one or more sensors on the device. In some aspects, the position data corresponding to the viewpoint position includes a pose of the device or a head of a user wearing the device. In some aspects, the position data corresponding to the viewpoint position includes six degrees of freedom (6DOF) position data.

In some aspects, the actions further include displaying the views of the 3D environment that include the determined depictions of the 3D content adjusted based on the changes to the plurality of portions of the 3D content. In some aspects, the sample shape includes a spherical shape.

In some aspects, the actions further include providing, to a second device different from the first device, the views of the 3D environment for display at the second device, wherein the views of the 3D environment include the determined depictions of the 3D content adjusted based on the changes to the plurality of portions of the 3D content.

In some aspects, the 3D environment includes an extended reality (XR) environment. In some aspects, the device is a head mounted device (HMD).

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1B illustrate exemplary electronic devices operating in a physical environment in accordance with some implementations.

FIGS. 2A-2B illustrate exemplary views of an extended reality (XR) environment provided by a device of FIG. 1A or 1B in accordance with some implementations.

FIG. 3 illustrates an example of different textures for lighting based on a sphere-based lighting representation in accordance with some implementations.

FIG. 4 illustrates an example of a lighting effect that remains constant for different viewpoints in accordance with some implementations.

FIG. 5 illustrates an example of a lighting effect that changes based on different viewpoints in accordance with some implementations.

FIG. 6 is a system flow diagram of an example generation of providing dynamic lighting adjustments for portions of content for a view of a three-dimensional (3D) environment in accordance with some implementations.

FIG. 7 is a flowchart illustrating a method for adjusting lighting of depictions of 3D content based on a representation that specifies lighting effects in accordance with some implementations.

FIG. 8 is a block diagram of an electronic device of in accordance with some implementations.

FIG. 9 is a block diagram of an exemplary head-mounted device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

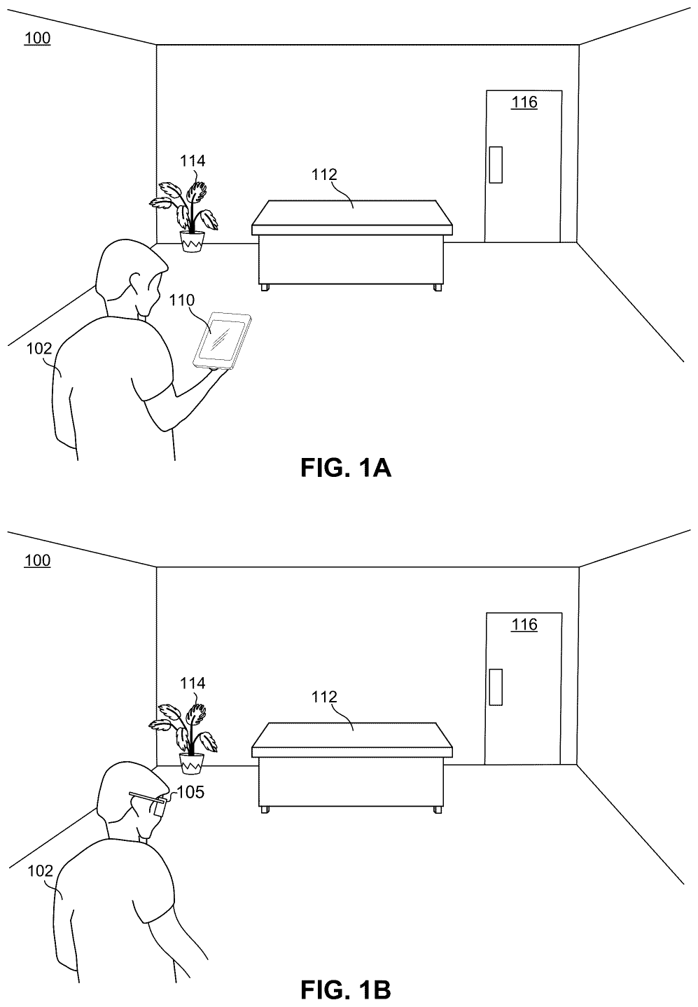

FIGS. 1A-1B illustrate exemplary electronic devices 105 and 110 operating in a physical environment 100. In the example of FIGS. 1A-1B, the physical environment 100 is a room that includes a desk 112, a plant 114, and a door 116. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system (e.g., a 3D space) associated with the XR environment, which may correspond to a 3D coordinate system of the physical environment 100.

In some implementations, video (e.g., pass-through video depicting a physical environment) is received from an image sensor of a device (e.g., device 105 or device 110) and used to present the XR environment. In other implementations, optical see-through may be used to present the XR environment by overlaying virtual content on a view of the physical environment seen through a translucent or transparent display. In some implementations, a 3D representation of a virtual environment is aligned with a 3D coordinate system of the physical environment. A sizing of the 3D representation of the virtual environment may be generated based on, inter alia, a scale of the physical environment or a positioning of an open space, floor, wall, etc. such that the 3D representation is configured to align with corresponding features of the physical environment. In some implementations, a viewpoint within the 3D coordinate system may be determined based on a position of the electronic device within the physical environment. The viewpoint may be determined based on, inter alia, image data, depth sensor data, motion sensor data, etc., which may be retrieved via a virtual inertial odometry system (VIO), a simultaneous localization and mapping (SLAM) system, etc.

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may have direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

In some implementations, the devices 105 and 110 obtain physiological data (e.g., EEG amplitude/frequency, pupil modulation, eye gaze saccades, etc.) from the user 102 via one or more sensors (e.g., a user facing camera). For example, the device 110 obtains pupillary data (e.g., eye gaze characteristic data) and may determine a gaze direction of the user 102. While this example and other examples discussed herein illustrates a single device 110 in a real-world physical environment 100, the techniques disclosed herein are applicable to multiple devices and multiple sensors, as well as to other real-world environments/experiences. For example, the functions of the device 110 may be performed by multiple devices.

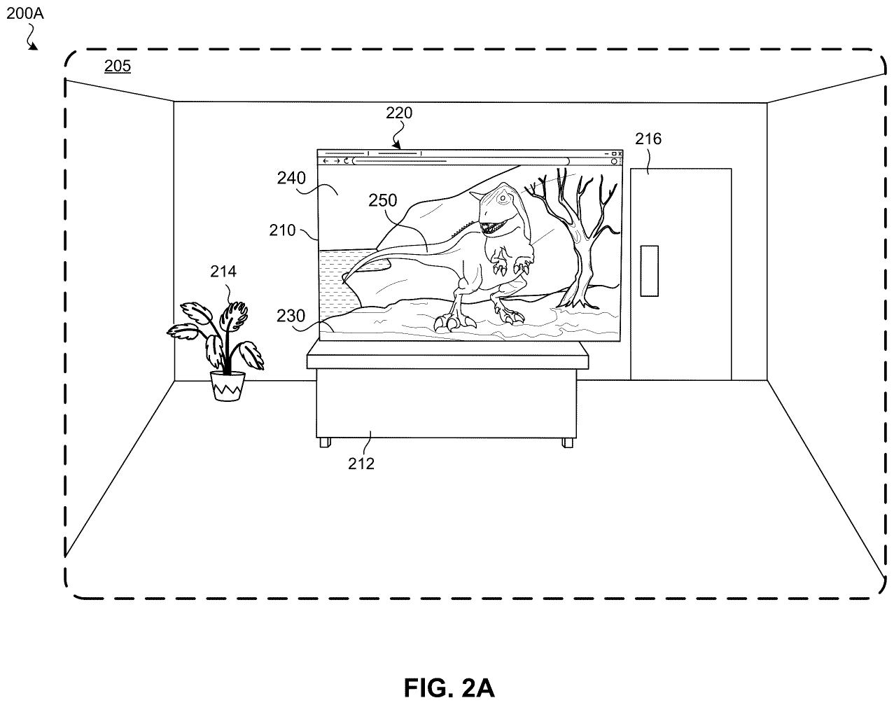

FIGS. 2A and 2B illustrate exemplary views 200A, 200B, respectively, of a 3D environment 205 provided by an electronic device (e.g., device 105 or 110 of FIG. 1). The views 200A, 200B may be a live camera view of the physical environment 100, a view of the physical environment 100 through a see-through display, or a view generated based on a 3D model corresponding to the physical environment 100. The views 200A, 200B may include depictions of aspects of the physical environment 100 such as a representation 212 of desk 112, representation 214 of plant 114, representation 216 of door 116, within a view of the 3D environment 205 (e.g., unless the content 220 obstructs the view of the depictions of the physical environment, as illustrated in view 200B of FIG. 2B). In particular, view 200A of FIG. 2A illustrates providing content 220 for display on a virtual screen 210, and view 200B of FIG. 2B illustrates providing content 220 for display within the 3D environment 205 (e.g., a more immersive view).

FIGS. 2A and 2B further illustrate multiple rendered frames of content 220 (e.g., 2D or 3D images or video, a 3D model or geometry, a combination thereof, or the like) within the views 200A-200B of the 3D environment 205. The content 220 in the illustrated examples provided herein (e.g., a depiction of a dinosaur walking along a rocky cliff near a body of water). The content 220 includes various elements, such as a foreground 230, a background 240, and a character 250 (e.g., the dinosaur). In some examples, each of these elements may be represented by a 3D model. In these examples, views of content 220 may be rendered based on the relative positioning between the content 220 and a viewing position (e.g., based on the position of device 105 or 110). In these examples, views of content 220 may be rendered based on the relative positioning between the 3D model(s), representation of the screen 210, a textured surface, and/or a viewing position (e.g., based on the position of device 105 or 110).

Additionally, or alternatively, in some implementations, an exemplary view of the content 220 may include only the content 220, such as an entire virtual environment (e.g., a fully immersive view), that may include environment lighting conditions associated with the content 220. For example, a user may see lighting conditions of the physical environment 100 in view 200A and 200B, but if in a fully immersive view (e.g., a virtual environment), the user may only see lighting conditions associated with the content 220. The lighting conditions of either the physical environment 100 and/or lighting conditions associated with the content 220 may be used to adjust lighting conditions of rendered content using one or more techniques, as further explained herein.

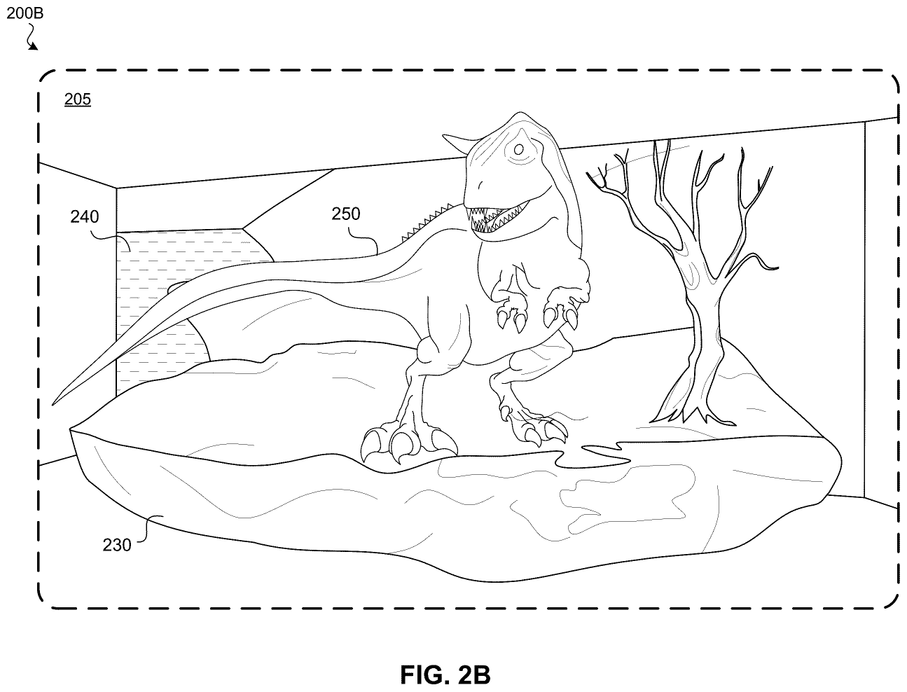

FIG. 3 illustrates an example view of an environment 300 for visualizing content and different textures for lighting based on a sphere-based lighting representation in accordance with some implementations. In some implementations, FIG. 3 illustrates a view, such as a developer's user interface, that provides a visualization of the environment lighting effects upon the character 250 from the view of the XR environment of FIG. 2.

According to an exemplary implementation, FIG. 3 illustrates generating a representation 310 that specifies lighting effects for a plurality of normal directions on a sample shape (e.g., a sphere) at a position of 3D content (e.g., a character or other object such as character 250) within a 3D environment (e.g., environment 200). For example, the lighting effects may be determined based on determined lighting conditions in the 3D environment (e.g., the physical environment 100 of the viewer (user 102), or from lighting of a virtual environment, if, for example, the user 102 is viewing the character 250 in a fully immersed virtual environment). For example, the lighting conditions of a 3D environment (e.g., lighting source(s) within a physical environment, a virtual environment, or an augment reality environment) may include particular luminance values and other lighting attributes (e.g., incandescent light, sunlight, etc.) that may affect an appearance of content or an object (e.g., character 250) within a 3D environment (e.g., environment 200).

In some implementations, the representation 310 may be a texture (e.g., a 32×32 pixel sampling) storing lighting information for multiple normal directions associated with multiple surface points on a generic shape. For example, the generic shape may be a two-dimensional (2D) shape, such as a projected sphere. In some implementations, generating the representation 310 may involve calculating a small (32×32) texture, as indicated by area 302, representing the lighting effects on surface points of a sphere at the position of an object or other content within the 3D environment. In some implementations, the representation 310 may store non-duplicative information, e.g., each value corresponding to different and/or spaced apart normal directions. In some implementations, higher mips (e.g., a version of a texture with a specific resolution) or slices may be stored in the representation 310 (e.g., dynamic spherelit) by taking advantage of a current texture setup that has space to store other additional information. For example, if a spherelit texture controls specular, the lighting adjustment techniques disclosed herein may have another mip level that is already sent to the GPU and in memory so that other information such as roughness may also be available for calculation. This process may provide an adjustment that includes a lower resolution, but depending on a particular adjustment requested or required, it may not matter, and provides a good optimization technique. In some implementations, separate textures for different effects may be associated with different mip levels, instead of a whole separate texture. For example, sample textures representing the lighting/shading effects may be hidden away in the same texture but using a different mip level for efficiency sake.

In some implementations, the lighting adjustment techniques disclosed herein may determine the changes to apply to a given portion of the 3D content by using a respective portion's normal direction to look up or sample information from the representation. For example, finding the lighting effect of the representation point having the most similar normal direction, such as at area 302. In some implementations, the techniques described herein may calculate multiple textures for different lighting effects (e.g., specular, diffuse, etc.) or may be modified based on determining different reflective properties associated with the materials of the object (e.g., skin of the character 250). For example, the specular radiance component 320 and the diffuse radiance component 330 provide a visualization of the specular radiance and diffuse radiance, respectively, for a series of sample textures representing the lighting/shading effects for screen space normals of a current camera perspective. Additionally, the specular radiance component 320 and the diffuse radiance component 330 may include mipmap levels for each sphere such that each sphere may include a number that represents a mipmap level. For example, as illustrated in FIG. 3, a specular radiance mipmap level 0 for sphere 322 and mipmap level 3 for sphere 324, and a diffuse radiance mipmap level 0 for sphere 332 and mipmap level 3 for sphere 334.

In exemplary implementations, the information stored in a sample texture is outgoing radiance values of some form. In some implementations, mip levels may be varied to provide an additional “dimension” for a sample texture. For example, if there is a corresponding X value for each surface normal direction, there may also be corresponding X data for each normal+Y data. In some implementations, Y data may be surface curvature information, surface roughness information (e.g., metalness or anisotropy values), surface occlusion information, surface position information, and/or other surface parametrizations necessary for a radiance model.

In some implementations, specular and/or diffuse radiance may be adjusted for particular areas on the character 250. For example, the skin, eyes, teeth, may each be adjusted differently for applying the lighting effects. In some implementations, a texture that represents representation 310 may be a combination of the specular radiance component 320 and the representation 310 calculated beforehand or the specular radiance component 320 and the representation 310 may be separate textures that are then chosen to be computed together at the GPU side. For example, this option of calculating some portions of the combination of the specular radiance component 320 and the representation 310 beforehand may be used for parts of the body that reflect the same lighting model, but one area uses specular, but another are does not.

In some implementations, the dynamic spherelits may be modulated by a variable rate rasterization (VRR) analysis. For example, modulation of the dynamic spherelits may be processed by choosing lower mip levels, and/or by updating the dynamic spherelits at a lower framerate if the lighting represented falls outside of the current fovation center. In some implementations, an expected eye resolution fall-off may be determined based on a VRR map, thus with the addition of VRR analysis, the modulation of the dynamic spherelits may become variable based on which zone of the display the pixels are in for the corresponding spherelit.

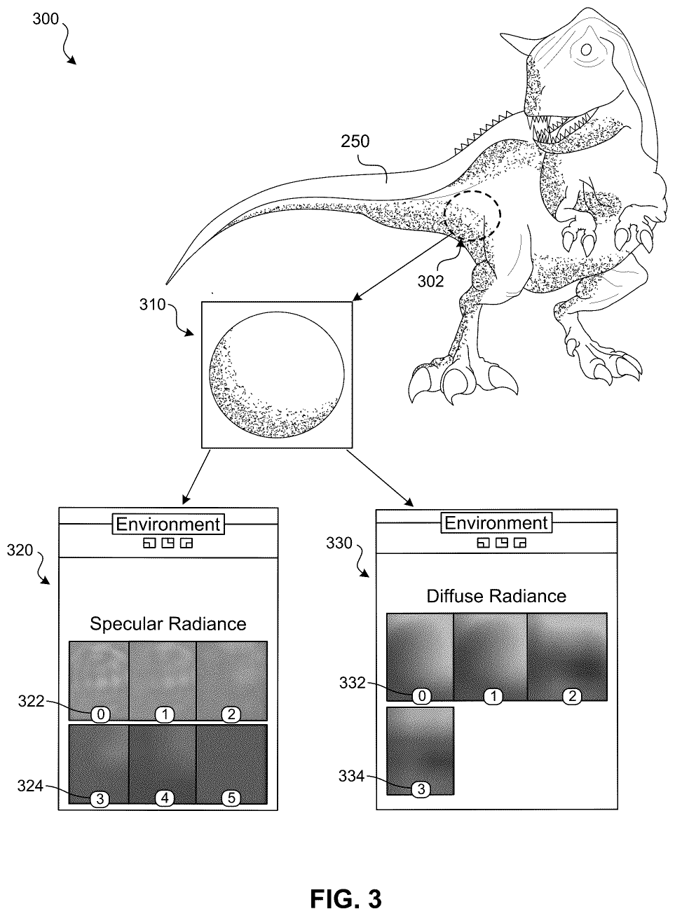

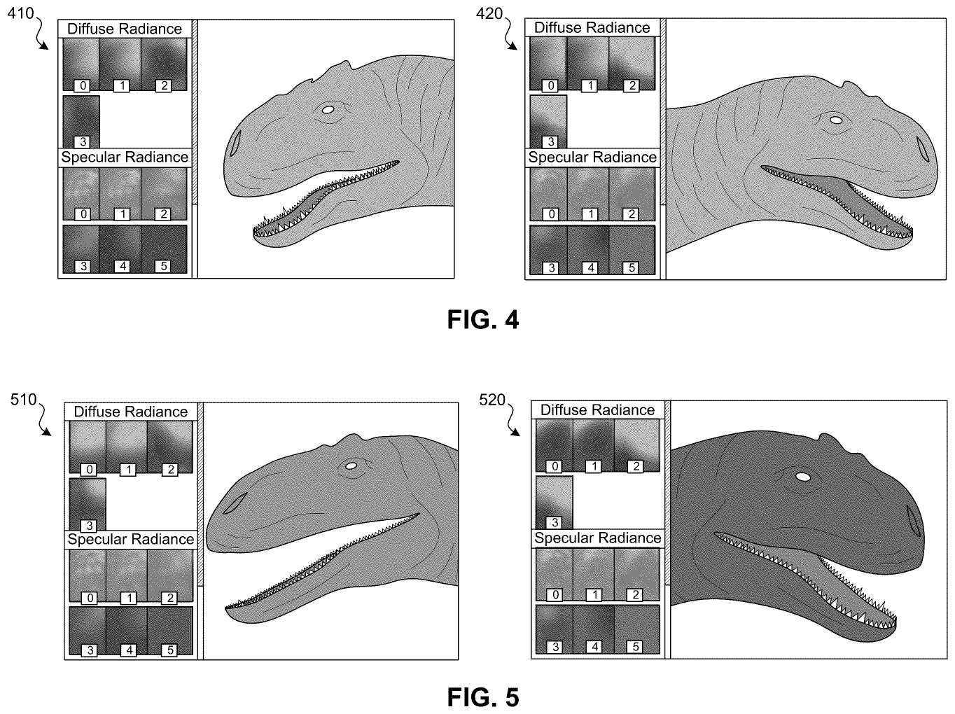

FIG. 4 illustrates an example of a lighting effect that remains constant for different viewpoints, and FIG. 5 illustrates an example of a lighting effect that changes based on different viewpoints in accordance with some implementations. For example, the screenshot 410 illustrates a first view of the character 250 (e.g., a left side of the dinosaur's head), and screenshot 420 illustrates a second view of the character 250 (e.g., a right side of the dinosaur's head), but the lighting effects remain the same. In contrast, the screenshot 510 illustrates a first view of the character 250 (e.g., a left side of the dinosaur's head), and screenshot 520 illustrates a second view of the character 250 (e.g., a right side of the dinosaur's head), but the lighting effects are now different because the viewpoint is taken into account when updating the light effects on the character 250, using one or more techniques described herein.

In some implementations, the viewer position data corresponding to the viewpoint position includes a pose of the device (e.g., device 105 or device 110) or a head of a user wearing the device (e.g., wearing an HMD, such as device 105). In some implementations, the viewer position data corresponding to the viewpoint position includes six degrees of freedom (6DOF) position data (e.g., 6DOF pose of the user). For example, the user's 102 viewpoint position and central focus may be towards the character 250 and a gaze direction focal point of the user 102 may be detected (e.g., the focus of the user 102 as he or she is viewing the character 250 displayed on the device). In some implementations, after determining a viewer position (e.g., a 6DOF pose), the lighting representation 310 (e.g., the sphere) may be updated based on the viewer position data to maintain a static orientation of the lighting effects specified by the representation 310 relative to the 3D environment. For example, the lighting data may be adjusted in the representation 310 based on rotating and translating the sample shape (e.g., the sphere) to correspond to a current viewpoint of the user 102, such that the shape and thus the representation 310 represents world-locked lighting information.

In some implementations, over a period of time, as a user's viewpoint within a 3D environment changes, the representation may be adjusted (e.g., reorienting the sample shape based on viewpoint changes) to maintain a static orientation of the lighting information in world-space, so that the stored lighting effects consistently correspond to the environment lighting over time. In some implementations, the representation may be used for multiple frames. For example, the representation doesn't need to be recalculated for every frame since a viewpoint may not change much between frames (e.g., a user looking at an object at a particular viewpoint for a long period of time).

In some implementations, a lighting representation may be associated with or aware of dynamic characters in an environment (e.g., a virtual character 250, such as a dinosaur) in order to account for occlusions. For example, the character 250 may be occluded in a current view based on a distance to a viewer's body, hands, or head, or the character 250 may be occluded based on the distance to another fully virtual character (one dinosaur occludes on another's spherelit, etc.).

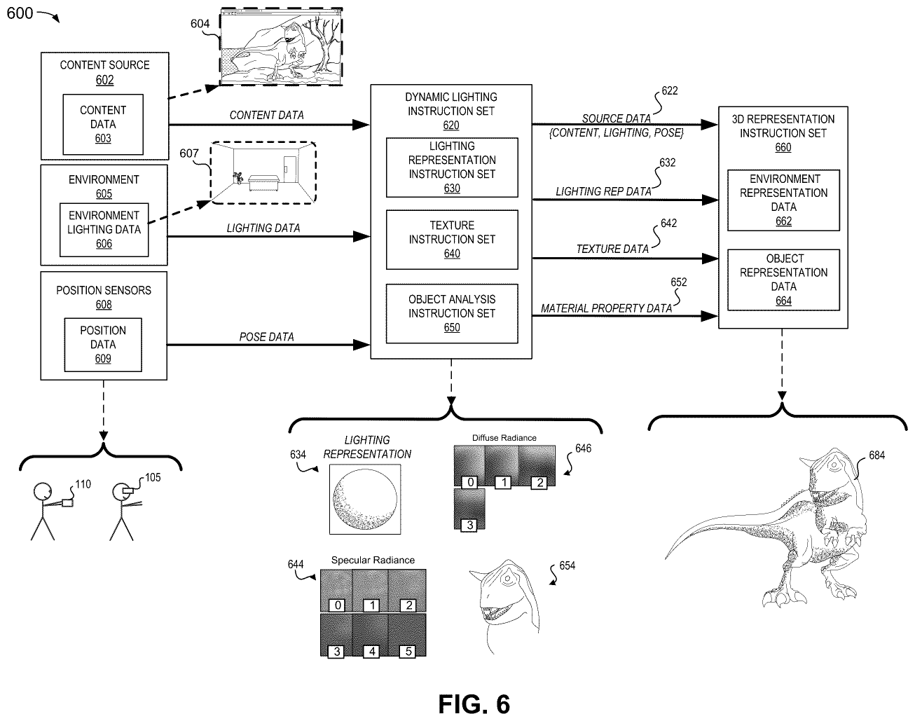

FIG. 6 illustrates a system flow diagram of an example environment 600 in which a system can provide dynamic lighting adjustments for portions of content for a view of a 3D environment according to some implementations. In some implementations, the system flow of the example environment 600 is performed on a device (e.g., device 105 or 110 of FIG. 1), such as a mobile device, desktop, laptop, or server device. The images of the example environment 600 can be displayed on a device (e.g., device 110 of FIG. 1) that has a screen for displaying images and/or a screen for viewing stereoscopic images such as an HMD (e.g., device 105 of FIG. 1). In some implementations, the system flow of the example environment 600 is performed on processing logic, including hardware, firmware, software, or a combination thereof. In some implementations, the system flow of the example environment 600 is performed on a processor executing code stored in a non-transitory computer-readable medium (e.g., a memory).

In an exemplary implementation, the system flow of the example environment 600 acquires content data to view on a device, lighting data from an environment, and pose data from a user's viewpoint, and provides dynamic lighting adjustments for portions of content for a view of a 3D environment. For example, content data 603 may be obtained from a content source 602, which may include content 604. For example, content 604 may be content 220 of FIG. 2, such as a 3D video or an animated figure, i.e., a dinosaur, character 250, walking around within a video screen or walking around within a view of a physical environment for augmented reality. The environment lighting data 606, from an environment 605 may be obtained from example environment 607 (e.g., lighting data from physical environment 100). The environment lighting data 606 may include lighting conditions of a 3D environment such as one or more lighting source(s) within a physical environment, a virtual environment, or an augment reality environment, and may include particular luminance values and other lighting attributes (e.g., incandescent light, sunlight, etc.) that may affect an appearance of content or an object (e.g., character 250) within a 3D environment (e.g., environment 200).

In an example implementation, the pose data may include camera positioning information such as position data 609 (e.g., position and orientation data, also referred to as pose data) from position sensors 608 of a physical environment. The position sensors 608 may be sensors on a viewing device (e.g., device 105 or 110 of FIG. 1). For the position data 609, some implementations include a visual inertial odometry (VIO) system to determine equivalent odometry information using sequential camera images (e.g., light intensity data) to estimate the distance traveled. Alternatively, some implementations of the present disclosure may include a SLAM system (e.g., using position sensors 608). The SLAM system may include a multidimensional (e.g., 3D) laser scanning and range measuring system that is GPS-independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In an example implementation, the environment 600 includes a dynamic lighting instruction set 620 that is configured with instructions executable by a processor to obtain content data, lighting data, and pose data (e.g., camera position information, etc.) and to determine lighting representation data 632, texture data 642, and/or material property data 652, using one or more of the techniques disclosed herein. In some implementations, dynamic lighting instruction set 620 includes a lighting representation instruction set 630 that is configured with instructions executable by a processor to analyze the obtained content data, lighting data, and pose data, and determine lighting representation data 632. For example, the lighting representation data 632 may include a lighting representation 634 (e.g., representation 310 of FIG. 3). For example, the lighting effects may be determined based on determined lighting conditions in a 3D environment (e.g., the physical environment 100 of the viewer (user 102), or from lighting of a virtual environment if the user 102 is viewing the character 250 in a fully immersed virtual environment). For example, the lighting conditions of a 3D environment (e.g., lighting source(s) within a physical environment, a virtual environment, or an augment reality environment) may include particular luminance values and other lighting attributes (e.g., incandescent light, sunlight, etc.) that may affect an appearance of content or an object (e.g., character 250) within a 3D environment (e.g., environment 200). For example, the representation 634 may be a texture (e.g., a 32×32 pixel sampling patch) storing lighting information for multiple normal directions associated with multiple surface points on a generic shape. For example, the generic shape may be a 2D shape, such as a projected sphere. Thus, instead of evaluating a lighting function over a large area of pixels (e.g., 2240×1984), a smaller patch (e.g., a 32×32) may be used, then sampling of the of patch may be more efficient to determine the lighting effects.

In some implementations, dynamic lighting instruction set 520 includes a lighting texture instruction set 640 that is configured with instructions executable by a processor to analyze the obtained content data, lighting data, and/or pose data, and determine texture data 642. For example, the texture data 642 may include specular radiance data 644 and/or diffuse radiance data 646 for one or more portions of the content data. For example, as illustrated in FIG. 3, the specular radiance component 320 and the diffuse radiance component 330 provide a visualization of the specular radiance and diffuse radiance, respectively, for a series of sample textures representing the lighting/shading effects for screen space normals of a current camera perspective.

In some implementations, dynamic lighting instruction set 620 includes an object analysis instruction set 650 that is configured with instructions executable by a processor to analyze the obtained content data, lighting data, and sensor data (e.g., image data such as light intensity data, depth data, camera position information, etc.), and determine material property data 652 for one or more objects within the environment. For example, the object analysis instruction set 650 obtains sensor data of an environment (e.g., image data of a physical environment such as the physical environment 100 of FIG. 1), performs an object detection and analysis process, and generates material property data 652 for the one or more detected objects. For example, as illustrated by image 654, the object detection and analysis process determines material property data 652 for the character 250 (e.g., physical properties of skin). In some implementations, specular and/or diffuse radiance may be adjusted for particular areas on the character 250. For example, the skin, eyes, teeth, may each be adjusted differently for applying the lighting effects. In some implementations, the object analysis instruction set 650 can determine other material properties of detected objects (both physical and virtual) such that the lighting effects may be adjusted accordingly. For example, physical properties of different materials such as glass, wood, metal, and/or light sources (e.g., properties of associated light rays from a light source), and other materials, may result in different lighting effects that may be accounted for when rendering content. For example, metallic or other types of materials may require some form of reflection to properly start looking like metallic surfaces (as metallic surfaces don't reflect diffuse light).

In an example implementation, the environment 600 further includes a 3D representation instruction set 660 that is configured with instructions executable by a processor to obtain the source data 622 (e.g., content data 603, lighting data 606, pose data 609) from the dynamic lighting instruction set 620, the lighting representation data 632 from the lighting representation instruction set 630, the texture data 642 from the texture instruction set 630, and/or the material property data 652 from the object analysis instruction set 650, and generates environment representation data 662 and object representation data 664 using one or more 3D rendering techniques. For example, the 3D representation instruction set 660 generates the 3D representation 684 (e.g., a 3D rendering of a dinosaur) based on dynamically adjusting the lighting using the lighting representation 634. For example, the lighting adjustment techniques disclosed herein may determine the changes to apply to a given portion of the 3D representation 684 by using a respective portion's normal direction to look up or sample information from the representation 634, e.g., finding the lighting effect of the representation point having the most similar normal direction. Over time, as the user's viewpoint within the 3D environment changes, the representation may be adjusted (e.g., reorienting the sample shape, representation 634, based on viewpoint changes) to maintain a static orientation of the lighting info in world-space, so that the stored lighting effects consistently correspond to the environment lighting over time. The representation can be used for multiple frames, e.g., doesn't need to be recalculated for every frame since viewpoint may not change much between frames. Additionally, the technique may apply different lighting effects based on the texture data 642 (e.g., specular, diffuse) or based on the material property data 652 (e.g., reflectivity may be different based on the material of the portion of the object/content, i.e., skin, metal, plastic, etc.).

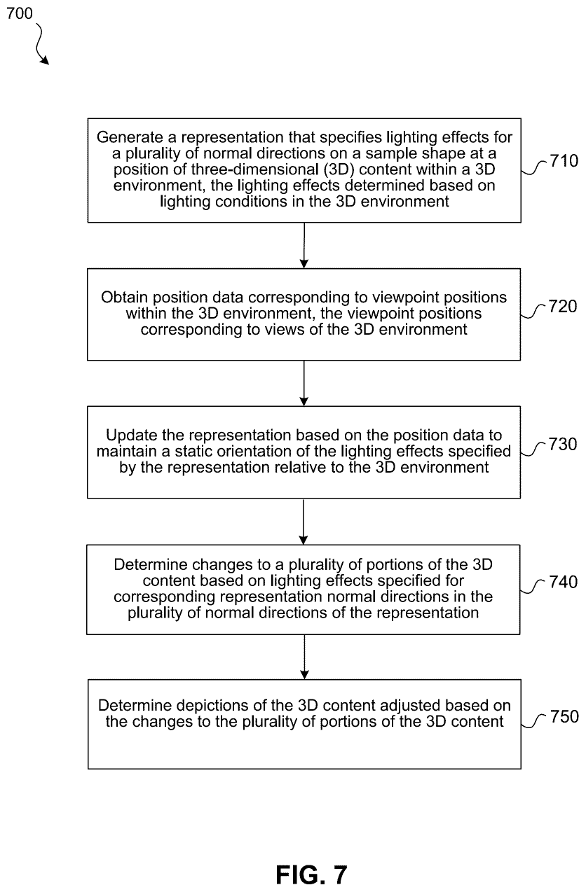

FIG. 7 is a flowchart illustrating a method 700 for rendering a view of a 3D environment based on a scale factor and a viewpoint position in accordance with some implementations. In some implementations, a device such as electronic device 110 performs method 500. In some implementations, method 500 is performed on a mobile device, desktop, laptop, HMD (e.g., device 110), or server device. The method 500 is performed by processing logic, including hardware, firmware, software, or a combination thereof. In some implementations, the method 500 is performed on a processor executing code stored in a non-transitory computer-readable medium (e.g., a memory). In some implementations, the device performing the method 500 includes a processor and one or more sensors.

At block 710, the method 700 generates a representation that specifies lighting effects for a plurality of normal directions on a sample shape at a position of 3D content within a 3D environment, the lighting effects determined based on lighting conditions in the 3D environment. For example, FIG. 3 illustrates generating a representation 310 that specifies lighting effects for a plurality of normal directions on a sample shape (e.g., a sphere) at a position of 3D content (e.g., a character or other object such as character 250) within a 3D environment (e.g., environment 200). For example, the lighting effects may be determined based on determined lighting conditions in the 3D environment (e.g., the physical environment 100 of the viewer (user 102), or from lighting of a virtual environment (e.g., if the user 102 is viewing the character 250 in a fully immersed virtual environment).

In some implementations, the representation 310 may be a texture (e.g., a 32×32 pixel sampling) storing lighting information for multiple normal directions associated with multiple surface points on a generic shape. For example, the generic shape may be a 2D shape, such as a projected sphere. In some implementations, generating the representation 310 may involve calculating a small (32×32) texture representing the lighting effects on surface points of a sphere at the position of an object or other content within the 3D environment. In some implementations, the representation 310 may store non-duplicative information, e.g., each value corresponding to different and/or spaced apart normal directions.

In some implementations, the representation includes a texture that stores lighting information for multiple normal directions associated with multiple surface points on the sample shape. For example, calculating a small (e.g., 32×32) texture representing the lighting effects on surface points of a sphere (e.g., lighting representation 310) at the position of an object or other content within the 3D environment. In some implementations, the representation includes a plurality of values, wherein each value of the plurality of values corresponds to a different normal direction, are positioned in a spatial arrangement (spaced apart), or a combination thereof (e.g., non-duplicative information).

In some implementations, the lighting effects are determined based on the lighting conditions in the 3D environment is based on sensor data from one or more sensors on the device. For example, the lighting conditions may be based on obtaining sensor data (e.g., ambient light data) from a physical environment (e.g., a room) that includes one or more light sources (e.g., a lamp, a ceiling light fixture, sunlight, etc.)

At block 720, the method 700 obtains position data corresponding to viewpoint positions within the 3D environment, the viewpoint positions corresponding to views of the 3D environment. In some implementations, the position data corresponding to the viewpoint position includes six degrees of freedom (6DOF) position data (e.g., 6DOF pose of the user). For example, the position and orientation data (e.g., pose data), may be acquired from the device 105 to determine the viewpoint of the user.

At block 730, the method 700 updates the representation based on the position data to maintain a static orientation of the lighting effects specified by the representation relative to the 3D environment. In some implementations, updating the representation includes adjusting data associated with the representation based on translatingthe sample shape to correspond to a current viewpoint. Additionally, or alternatively, in some implementations, updating the representation includes adjusting data associated with the representation based on rotating the sample shape to correspond to a current viewpoint. For example, updating the representation may include adjusting the data in the representation based on rotating and/or translating the sample shape (e.g., a sphere) to correspond to the current viewpoint such that the shape and thus the representation represents world-locked lighting information.

At block 740, the method 700 determines changes to a plurality of portions of the 3D content based on lighting effects specified for corresponding representation normal directions in the plurality of normal directions of the representation. In an exemplary implementation, the corresponding representation normal directions are identified based on similarity to normal directions of the plurality of portions of the 3D content. For example, for each pixel sample the texture at the corresponding normal is determined to apply the lighting effects. In other words, for any normal on an object, looking up a value (e.g., a lighting value) on the representation, and adjusting a portion of the content (e.g., adjusting a portion of the object) based on the value. For example, for character 250, based on a sample portion of the character 250, looking up a lighting value on the corresponding portion of the representation 310 and apply the lighting value to that portion of the character 250. In some implementations, this may involve rendering an outgoing radiance by sampling image-based lighting (IBL) cube map estimated via machine learning techniques or implementing another complex shading function.

In some implementations, determining the changes to the plurality of the portions of the 3D content based on lighting effects specified for corresponding representation normal directions in the plurality of normal directions of the representation includes applying the lighting effects based on a sample texture value at a corresponding normal for each pixel of a plurality of pixels within a current view.

In some implementations, determining the changes to the plurality of the portions of the 3D content based on lighting effects specified for corresponding representation normal directions in the plurality of normal directions of the representation includes rendering an outgoing radiance. In some implementations, rendering the outgoing radiance is based on sampling IBL from sensor data, or implementing other complex shading functions. For example, sampling IBL may come from sensor data, but in some instances, sampling IBL may also be authored offline, created in real-time, or any variation between.

In some implementations, the views of the 3D environment include a viewing frame rate, wherein the depictions of the 3D content that are adjusted based on the changes to the plurality of portions of the 3D content are updated at a light adjustment frame rate that is a different (slower) frame rate than the viewing frame rate. Thus, based on the different update frame rate, there may not be a need to calculate the lighting adjustments for every frame.

At block 750, the method 700 determines depictions of the 3D content adjusted based on the changes to the plurality of portions of the 3D content. For example, the depictions of the 3D content, such as character 250, are adjusted based on the changes to the plurality of portions of the 3D content associated with the lighting representation 310.

In some implementations, the method 700 further includes displaying the views of the 3D environment that include the determined depictions of the 3D content adjusted based on the changes to the plurality of portions of the 3D content (e.g., the same device, such as device 105 or 110, determines and displays the lighting adjustments). Alternatively, in some implementations, the method 700 further includes providing, to a second device different from the first device, the views of the 3D environment for display at the second device, wherein the views of the 3D environment include the determined depictions of the 3D content adjusted based on the changes to the plurality of portions of the 3D content (e.g., a different device determines the lighting adjustments than the device that displays the views of the 3D environment).

In an exemplary implementation, edge computing techniques (e.g., emerging computing paradigm which refers to a range of networks and devices at or near the user) may be utilized for the method 700. In other words, two or more devices may be utilized in the processes described herein. In some implementations, the device is a first device (e.g., an HMD), wherein the views of the 3D environment that include depictions of the adjusted 3D content are updated based on a generation and rotation-based adjustment of the representation by a second device. Additionally, or alternatively, in some implementations, the changes to the plurality of portions of the 3D content based on additional lighting effects specified for corresponding representation normal directions in the plurality of normal directions of the representation are obtained from one or more other devices that are different than the first device. For example, an HMD may determine the generation and rotation-based adjustment of the representation may be performed remotely from an HMD that is displaying the content based on current device pose and/or other info provided by the HMD.

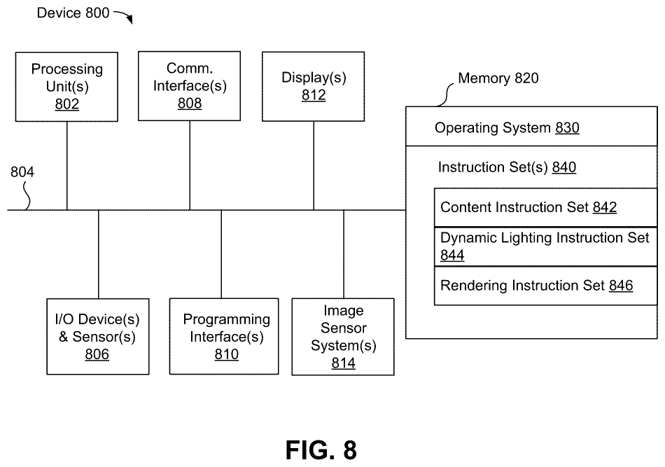

FIG. 8 is a block diagram of electronic device 800. Device 800 illustrates an exemplary device configuration for electronic device 110. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 800 includes one or more processing units 802 (e.g., microprocessors, ASICs, FPGAs, GPUs, CPUs, processing cores, and/or the like), one or more input/output (I/O) devices and sensors 806, one or more communication interfaces 808 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, and/or the like type interface), one or more programming (e.g., I/O) interfaces 810, one or more output device(s) 812, one or more interior and/or exterior facing image sensor systems 814, a memory 820, and one or more communication buses 804 for interconnecting these and various other components.

In some implementations, the one or more communication buses 804 include circuitry that interconnects and controls communications between system components. In some implementations, the one or more I/O devices and sensors 806 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 812 include one or more displays configured to present a view of a 3D environment to the user. In some implementations, the one or more device(s) 812 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 800 includes a single display. In another example, the device 800 includes a display for each eye of the user.

In some implementations, the one or more output device(s) 812 include one or more audio producing devices. In some implementations, the one or more output device(s) 812 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 812 may additionally or alternatively be configured to generate haptics.

In some implementations, the one or more image sensor systems 814 are configured to obtain image data that corresponds to at least a portion of a physical environment. For example, the one or more image sensor systems 814 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 814 further include illumination sources that emit light, such as a flash. In various implementations, the one or more image sensor systems 814 further include an on-camera image signal processor (ISP) configured to execute a plurality of processing operations on the image data.

The memory 820 includes high-speed random-access memory, such as DRAM, SRAM, DDR RAM, or other random-access solid-state memory devices. In some implementations, the memory 820 includes non-volatile memory, such as one or more magnetic disk storage devices, optical disk storage devices, flash memory devices, or other non-volatile solid-state storage devices. The memory 820 optionally includes one or more storage devices remotely located from the one or more processing units 802. The memory 820 includes a non-transitory computer readable storage medium.

In some implementations, the memory 820 or the non-transitory computer readable storage medium of the memory 820 stores an optional operating system 830 and one or more instruction set(s) 840. The operating system 830 includes procedures for handling various basic system services and for performing hardware dependent tasks. In some implementations, the instruction set(s) 840 include executable software defined by binary information stored in the form of an electrical charge. In some implementations, the instruction set(s) 840 are software that is executable by the one or more processing units 802 to carry out one or more of the techniques described herein.

The instruction set(s) 840 includes a content instruction set 842, a dynamic lighting instruction set 844, and a rendering instruction set 846. The instruction set(s) 940 may be embodied a single software executable or multiple software executables.

In some implementations, the content instruction set 842 is executable by the processing unit(s) 802 to provide and/or track content for display on a device. The content instruction set 842 may be configured to monitor and track the content over time (e.g., during an experience) and/or to identify change events that occur within the content (e.g., based on identified/classified behavior gaze events). To these ends, in various implementations, the instruction includes instructions and/or logic therefor, and heuristics and metadata therefor.

In some implementations, the dynamic lighting instruction set 844 is executable by the processing unit(s) 802 to obtain content data, lighting data, and pose data (e.g., camera position information, etc.) and to determine lighting representation data, texture data, and/or material property data, using one or more of the techniques disclosed herein. To these ends, in various implementations, the instruction includes instructions and/or logic therefor, and heuristics and metadata therefor.

In some implementations, the rendering instruction set 846 is executable by the processing unit(s) 802 to obtain the source data (e.g., content data, lighting data, pose data) from the dynamic lighting instruction set, the lighting representation data from the lighting representation instruction set, the texture data from the texture instruction set, and/or the material property data from the object analysis instruction set, and generates environment representation data and object representation data using one or more 3D rendering techniques discussed herein or as otherwise may be appropriate. To these ends, in various implementations, the instruction includes instructions and/or logic therefor, and heuristics and metadata therefor.

Although the instruction set(s) 840 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

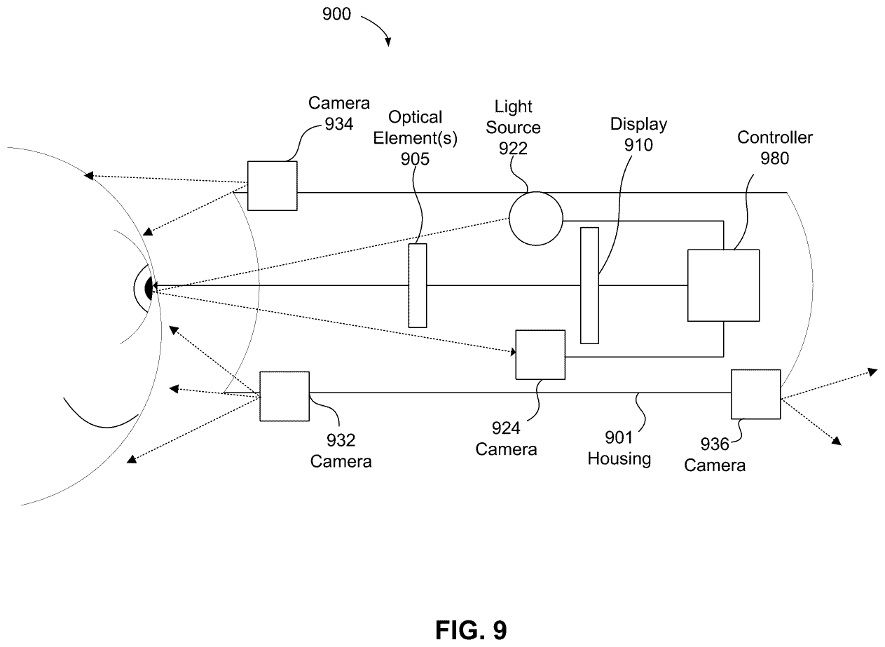

FIG. 9 illustrates a block diagram of an exemplary head-mounted device 900 in accordance with some implementations. The head-mounted device 900 includes a housing 901 (or enclosure) that houses various components of the head-mounted device 900. The housing 901 includes (or is coupled to) an eye pad (not shown) disposed at a proximal (to the user 102) end of the housing 901. In various implementations, the eye pad is a plastic or rubber piece that comfortably and snugly keeps the head-mounted device 900 in the proper position on the face of the user 102 (e.g., surrounding the eye of the user 102).

The housing 901 houses a display 910 that displays an image, emitting light towards or onto the eye of a user 102. In various implementations, the display 910 emits the light through an eyepiece having one or more optical elements 905 that refracts the light emitted by the display 910, making the display appear to the user 102 to be at a virtual distance farther than the actual distance from the eye to the display 910. For example, optical element(s) 905 may include one or more lenses, a waveguide, other diffraction optical elements (DOE), and the like. For the user 102 to be able to focus on the display 910, in various implementations, the virtual distance is at least greater than a minimum focal distance of the eye (e.g., 7 cm). Further, in order to provide a better user experience, in various implementations, the virtual distance is greater than 1 meter.

The housing 901 also houses a tracking system including one or more light sources 922, camera 924, camera 932, camera 934, camera 936, and a controller 980. The one or more light sources 922 emit light onto the eye of the user 102 that reflects as a light pattern (e.g., a circle of glints) that may be detected by the camera 924. Based on the light pattern, the controller 980 may determine an eye tracking characteristic of the user 102. For example, the controller 980 may determine a gaze direction and/or a blinking state (eyes open or eyes closed) of the user 102. As another example, the controller 980 may determine a pupil center, a pupil size, or a point of regard. Thus, in various implementations, the light is emitted by the one or more light sources 922, reflects off the eye of the user 102, and is detected by the camera 924. In various implementations, the light from the eye of the user 102 is reflected off a hot mirror or passed through an eyepiece before reaching the camera 924.

The display 910 emits light in a first wavelength range and the one or more light sources 922 emit light in a second wavelength range. Similarly, the camera 924 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 102 selects an option on the display 910 by looking at it), provide foveated rendering (e.g., present a higher resolution in an area of the display 910 the user 102 is looking at and a lower resolution elsewhere on the display 910), or correct distortions (e.g., for images to be provided on the display 910).

In various implementations, the one or more light sources 922 emit light towards the eye of the user 102 which reflects in the form of a plurality of glints.

In various implementations, the camera 924 is a frame/shutter-based camera that, at a particular point in time or multiple points in time at a frame rate, generates an image of the eye of the user 102. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 924 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 932, camera 934, and camera 936 are frame/shutter-based cameras that, at a particular point in time or multiple points in time at a frame rate, may generate an image of the face of the user 102 or capture an external physical environment. For example, camera 932 captures images of the user's face below the eyes, camera 934 captures images of the user's face above the eyes, and camera 936 captures the external environment of the user (e.g., environment 100 of FIG. 1). The images captured by camera 932, camera 934, and camera 936 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a processor of a device:
generating a representation that specifies lighting effects for a plurality of normal directions on a sample shape at a position of three-dimensional (3D) content within a 3D environment, the lighting effects determined based on lighting conditions in the 3D environment;
obtaining position data corresponding to viewpoint positions within the 3D environment, the viewpoint positions corresponding to views of the 3D environment;
updating the representation based on the position data to maintain a static orientation of the lighting effects specified by the representation relative to the 3D environment;
determining changes to a plurality of portions of the 3D content based on lighting effects specified for corresponding representation normal directions in the plurality of normal directions of the representation, the corresponding representation normal directions identified based on similarity to normal directions of the plurality of portions of the 3D content; and
determining depictions of the 3D content adjusted based on the changes to the plurality of portions of the 3D content.

2. The method of claim 1, wherein the representation comprises a texture that stores lighting information for multiple normal directions associated with multiple surface points on the sample shape.

3. The method of claim 1, wherein the representation comprises a plurality of values, wherein each value of the plurality of values corresponds to a different normal direction, are positioned in a spatial arrangement, or a combination thereof.

4. The method of claim 1, wherein determining the changes to the plurality of the portions of the 3D content based on lighting effects specified for corresponding representation normal directions in the plurality of normal directions of the representation comprises applying the lighting effects based on a sample texture value at a corresponding normal for each pixel of a plurality of pixels within a current view.

5. The method of claim 1, wherein determining the changes to the plurality of the portions of the 3D content based on lighting effects specified for corresponding representation normal directions in the plurality of normal directions of the representation comprises rendering an outgoing radiance.

6. The method of claim 5, wherein rendering the outgoing radiance is based on sampling image-based lighting (IBL) from sensor data.

7. The method of claim 1, wherein the views of the 3D environment comprise a viewing frame rate, wherein the depictions of the 3D content that are adjusted based on the changes to the plurality of portions of the 3D content are updated at a light adjustment frame rate that is a different frame rate than the viewing frame rate.

8. The method of claim 1, wherein updating the representation comprises adjusting data associated with the representation based on translating the sample shape to correspond to a current viewpoint.

9. The method of claim 1, wherein updating the representation comprises adjusting data associated with the representation based on rotating the sample shape to correspond to a current viewpoint.

10. The method of claim 1, wherein the device is a first device, wherein the views of the 3D environment that include depictions of the adjusted 3D content are updated based on a generation and rotation-based adjustment of the representation by a second device.

11. The method of claim 1, wherein the device is a first device, and wherein the changes to the plurality of portions of the 3D content based on additional lighting effects specified for corresponding representation normal directions in the plurality of normal directions of the representation are obtained from one or more other devices that are different than the first device.

12. The method of claim 1, wherein the lighting effects are determined based on the lighting conditions in the 3D environment is based on sensor data from one or more sensors on the device.

13. The method of claim 1, wherein the position data corresponding to the viewpoint position comprises a pose of the device or a head of a user wearing the device.

14. The method of claim 1, wherein the position data corresponding to the viewpoint position comprises six degrees of freedom (6DOF) position data.

15. The method of claim 1, further comprising:
displaying the views of the 3D environment that include the determined depictions of the 3D content adjusted based on the changes to the plurality of portions of the 3D content.

16. The method of claim 1, wherein the device is a first device, the method further comprising:
providing, to a second device different from the first device, the views of the 3D environment for display at the second device, wherein the views of the 3D environment include the determined depictions of the 3D content adjusted based on the changes to the plurality of portions of the 3D content.

17. The method of claim 1, wherein the sample shape comprises a spherical shape.

18. The method of claim 1, wherein the 3D environment comprises an extended reality (XR) environment.

19. The method of claim 1, wherein the device is a head mounted device (HMD).

20. A device comprising:
one or more sensors;
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
generating a representation that specifies lighting effects for a plurality of normal directions on a sample shape at a position of three-dimensional (3D) content within a 3D environment, the lighting effects determined based on lighting conditions in the 3D environment;
obtaining position data corresponding to viewpoint positions within the 3D environment, the viewpoint positions corresponding to views of the 3D environment;
updating the representation based on the position data to maintain a static orientation of the lighting effects specified by the representation relative to the 3D environment;
determining changes to a plurality of portions of the 3D content based on lighting effects specified for corresponding representation normal directions in the plurality of normal directions of the representation, the corresponding representation normal directions identified based on similarity to normal directions of the plurality of portions of the 3D content; and
determining depictions of the 3D content adjusted based on the changes to the plurality of portions of the 3D content.

21. A non-transitory computer-readable storage medium, storing program instructions executable on a device to perform operations comprising:
generating a representation that specifies lighting effects for a plurality of normal directions on a sample shape at a position of three-dimensional (3D) content within a 3D environment, the lighting effects determined based on lighting conditions in the 3D environment;
obtaining position data corresponding to viewpoint positions within the 3D environment, the viewpoint positions corresponding to views of the 3D environment;
updating the representation based on the position data to maintain a static orientation of the lighting effects specified by the representation relative to the 3D environment;
determining changes to a plurality of portions of the 3D content based on lighting effects specified for corresponding representation normal directions in the plurality of normal directions of the representation, the corresponding representation normal directions identified based on similarity to normal directions of the plurality of portions of the 3D content; and
determining depictions of the 3D content adjusted based on the changes to the plurality of portions of the 3D content.
